(19) United States
(12) Patent Application Publication
(10) Pub. No.: US 2026/0161397 A1
(43) Pub. Date: Jun. 11, 2026

(54) COMPUTING DEVICE FOR LOW-POWER QUARTER ROUND OPERATION

(71) Applicant: Soteria Inc., Seoul (KR)

(72) Inventors: James Jongman KIM, Seoul (KR); Chang Il SON, Gwacheon-si (KR)

(73) Assignee: Soteria Inc., Seoul (KR)

(21) Appl. No.: 19/123,896

(22) PCT Filed: Sep. 1, 2023
(86) PCT No.: PCT/KR2023/013075

§ 371 Date: Apr. 24, 2025

(30) Foreign Application Priority Data
Oct. 27, 2022 (KR) 10-2022-0140387

(51) Int. Cl. G06F 9/30; G06F 1/324; H04L 9/06

(52) U.S. Cl. CPC G06F 9/30029; G06F 1/324; H04L 9/065

(57) ABSTRACT

The present disclosure relates to a computing device for low-power quarter round operation, especially to reducing power consumption of a computing device for a quarter round operation by segmenting adder into a plurality of sub-adders and suppressing glitches in the output of each of the sub-adder while processing quarter round operation, which is used for a stream cipher, at high speed through hardware. The combinational logic circuit for quarter round operation is segmented into predetermined bit units to form pipelines composed of predetermined stages, so the segmentation and pipelining not only improve processing speed but also prevent glitch propagation.

### TECHNICAL FIELD

The present disclosure relates to a computing device for low-power quarter round operation, in more detail, to reducing power consumption of a computing device for a quarter round operation by segmenting adder into a plurality of sub-adders and suppressing glitches in the output of each of the sub-adder while processing quarter round operation, which is used for a stream cipher, at high speed through hardware. The combinational logic circuit for quarter round operation is segmented into predetermined bit units to form pipelines composed of predetermined stages, so the segmentation and pipelining not only improve processing speed but also prevent glitch propagation.

### BACKGROUND ART

Recently, interest in virtual currencies is increasing and virtual currencies are based on blockchains. A blockchain is considered as a large-scale ledger in virtual currency transaction that is constructed in accordance with a distributed and decentralized system.

Nodes of a network that participate in transaction verification and block creation in virtual currencies are called miners and miners continuously mine block headers using a hash function until requests of blockchains are satisfied. Miners that participate in a mining process have to solve resource-integrated tasks based on Proof-of-Work (PoW) consensus mechanism.

A hash function required for PoW is an important difference between various virtual currencies including bitcoin. It is required to construct a specified hardware that processes stream ciphers in order to improve the mining performance of miners. Further, miners have to reduce power consumption.

A stream cipher had been known as being vulnerable more than a block cipher, but Salsa20 or ChaCha developed by Daniel J. Bernstein has been known as a method of designing a safe stream cipher, and Bluetooth connection, 4G communication of mobile phones, Transport Layer Security (TLS) connection, etc. are safely protected by stream ciphers.

As described above, mining of virtual currencies is performed on the basis of PoW in which miners have to solve complicated problems using a hardware power source. A fundamental model of a virtual currency mining system includes a hash algorithm hardware module that uses a block header as input.

Parameters that are required for a hash algorithm using a hash cipher are adjusted by applying intention of a user in accordance with the capacity of a memory, available computing power, and other factors. The stream cipher algorithm creates a key stream by receiving a key and a nonce. A ciphertext is obtained by performing Exclusive-OR (XOR) on a key stream and a plain text, and the plain text is obtained by performing XOR on the ciphertext with the key stream. The key and the nonce in a stream cipher are reused, but when they are reused, the same key stream as the previous one is created, so they should not be simultaneously reused.

Two ciphers that cryptographers have given attention to for a long period of time are RC4 and Salsa20, and vulnerabilities of RC4 that is a stream cipher that have been the most generally used have been exposed through reverse engineering. Meanwhile, Salsa20 transforms a 512-bit block composed of one key, one nonce, and a counter value using a core algorithm and adds the result to the original 512-bit block, thereby calculating one key stream block (see FIG. 1A).

The core algorithm used for transformation in this case is a quarter round function. A quarter round function transforms four 32-bit words (a, b, c, d) as follows. That is, the words are transformed into relations, b=b xor [(a+d)<<<7], c=c xor [(b+a)<<<9], d=d xor [(c+b)<<<13], and a=a xor [(d+c)<<<18].

Meanwhile, Salsa20 was designed by Daniel J. Bernstein in 2005 and was filed later for eSTREAM EU cryptography validation process. ChaCha is a revision of Salsa 20, published in 2008. A new round function that increases spread and improves performance is used in some cryptography architectures.

Meanwhile, a quarter round function that is used in ChaCha transforms words (a, b, c, d) as follows. That is, ChaCha transforms the words by performing a+=b; d \hat{ }=a; d<<<=16; c+=d; b \hat{ }=c; b<<<=12; a+=b; d\hat{ }=a; and d<<<=8; c+=d; b\hat{ }=c; b<<<=7.

As described above, a quarter round (QR) function is performed as a set of an adder, a rotation unit, and XOR operation unit, and power consumption due to such QR operation excessively increases in virtual currency mining systems, which causes even environmental problems. Accordingly, it is required to improve the performance and reduce power consumption in QR.

Accordingly, the present disclosure relates to a computing device for low-power quarter round operation using a circuit that reduces a glitch, and in detail, the present disclosure intends to propose a circuit that decreases power consumption by reducing a glitch while processing a quarter round function, which is used for a stream cipher, at a high speed through hardware.

Next, the prior art in the field of the present disclosure will be briefly described and then technological matters that the present disclosure intends to achieve differently from the prior art will be described.

First, in Hardware Implementation For Fast Block Generator Of Litecoin Blockchain System” (see pages 9-14 in ISEE 2021) published in 2021 ISEE (International Symposium on Electrical and Electronics Engineering) by Duong, etc., a QR datapath is proposed through three separate stages, but this is not different from the structure proposed before in Salsa20/8.

Further, a hardware accelerator about cryptography for high-performance authentication is described and a quarter round is proposed in US 2019/0042249 A1 (2019 Feb. 7), but special improvement of the structure of a quarter round itself is not addressed.

Accordingly, the present disclosure intends to not only improve the performance of a virtual currency mining system, but solve even environmental problems by reducing power consumption, by proposing a computing device for low-power quarter round operation. The present disclosure intends to propose a computing device for a quarter round circuit that reduces a glitch at an output end of a combinational logic circuit and improves a processing speed by dividing each adder into a plurality of sub-adders when designing a computing device for low-power quarter round operation and by sequentially latching results of the adder to be fitted to a delay model due to delay of each of the sub-adders, and a method of configuring the circuit.

There is no description and suggestion or intimation about the idea and structure of the present disclosure described above, it is apparent that the idea of the present disclosure is new and advanced.

### DETAILED DESCRIPTION OF THE INVENTION

### Technical Problem

The present disclosure has been made in an effort to solve the problems described above and an objective of the present disclosure is to provide a computing device for low-power quarter round operation, the computing device decreasing power consumption by reducing a glitch that is generated by a result that is output with a time difference from an adder in a circuit for computing a quarter round function.

Further, another objective of the present disclosure is to configure a computing device for a quarter round operation that includes an adder adding two data words, a rotation unit shifting an addition result of the adder, and an operation unit performing exclusive OR (XOR) on the shifted result with another data word, into a low-power circuit.

Further, another objective of the present disclosure is to reduce the hardware size of a computing device for low-power quarter round operation and increase the processing speed by configuring shifting by predetermined bits for an addition result of an adder through only wiring.

Further, another objective of the present disclosure is to configure a circuit that prevents propagation of glitches by constituting a rotation unit through wiring and by further providing a latch unit before or after the wiring in a computing device for low-power quarter round operation.

Further, another objective of the present disclosure is to provide a computing device for low-power quarter round operation, the computing device decreasing power consumption by preventing propagation of glitch, which is generated in an entire adder, in an early stage by dividing the adder, which constitutes the computing device for low-power quarter round operation, into a plurality of small-scale sub-adders and by latching a result of each of the sub-adders in an early stage immediately after calculation.

Further, another objective of the present disclosure is to decrease power consumption due to a glitch by latching a result of each of small-scale sub-adders in an early stage by modeling a delay of each of the small-scale sub-adders as the result of dividing an adder into the small-scale sub-adders when configuring a computing device for low-power quarter round operation.

### Problem Solving Means

A computing device for low-power quarter round operation according to an embodiment of the present disclosure includes: an adder adding two data words each having a predetermined bit width; a rotation unit rotating predetermined bits in an addition result of the adder in a predetermined direction; an XOR operation unit performing bitwise exclusive OR on the rotation result with a predetermined another data word; and a latch unit latching the result of the adder or the rotation unit, in which power consumption is reduced by preventing propagation of glitches using the latch unit.

Further, the latch unit is configured to latch the addition result of the adder or the rotation result of the rotation unit in synchronization with carry propagation of the adder, thereby preventing propagation of glitches due to the result of the adder.

Further, the rotation unit performs wiring such that output of the adder is shifted to the left by predetermined bits and connected to input of the XOR operation unit, and has a latch unit provided before or after the wiring, thereby suppressing glitches in the addition result of the adder from propagating to the XOR operation unit. Of course, it is preferable to have the latch unit before the wiring.

Further, the adder is composed of a plurality of sub-adders having input in which the two data words are divided into smaller data words, and is configured by cascading such that a carry is propagated and connected from a Least Significant Bit (LSB) to a Most Significant Bit (MSB) between the plurality of sub-adders.

Further, the latch unit is divided into a plurality of sub-latch units to correspond to code words of the results of the sub-adders and a clock of each of the sub-latch units is delayed and supplied more than the maximum delay of the sub-adders, thereby preventing glitches from propagating to the XOR operation unit.

The computing device for low-power quarter round operation further includes a clock delay unit supplying a clock delayed by a delay model according to delays of the sub-adders to each of the plurality of sub-latch units.

The computing device for low-power quarter round operation is applied to operate a quarter round function in a Salsa or ChaCha stream cipher unit.

Meanwhile, a method of configuration a computing device for low-power quarter round operation according to another embodiment of the present disclosure comprises: adding two data words each having a predetermined bit width through an adder; rotating predetermined bits in an addition result of the adder in a predetermined direction through a rotation unit; performing bitwise exclusive OR on the rotation result with a predetermined another data word through an XOR operation unit; and latching the result of the adder or the rotation unit through a latch unit, in which propagation of glitches is suppressed through the latching, whereby power consumption is reduced.

The latching is configured to latch the addition result of the adder or the rotation result of the rotation unit in synchronization with carry propagation of the adder, the rotating is performed by wiring such that output of the adder is shifted to the left by predetermined bits and connected to input of the XOR operation unit, and the latching is provided before or after the wiring, thereby suppressing glitches in the addition result of the adder from propagating to the XOR operation unit.

The adding includes configuring a plurality of sub-adders having input in which the two data words are divided into smaller data words, and includes cascading such that a carry is propagated and connected from an LSB to an MSB between the plurality of sub-adders; and the latching includes configuring a plurality of sub-latch units to correspond to code words of the results of the sub-adders and delaying and supplying a clock of each of the sub-latch units more than a maximum delay of a corresponding sub-adder, thereby suppressing propagation of glitches to the XOR operation unit.

The method of configuring a computing device for low-power quarter round operation further includes supplying a clock delayed by a delay model according to delays of the sub-adders to each of the plurality of sub-latch units.

The method of configuring a computing device for low-power quarter round operation is applied to operate a quarter round function in a Salsa or ChaCha stream cipher unit.

### Effects of the Invention

As described above, the computing device for low-power quarter round operation of the present disclosure has an effect of performing high-speed processing by reducing a critical path delay of a datapath using a pipeline structure and of reducing power consumption by maximally suppressing propagation of glitches by inserting a latch operating as a delay model according a delay into the result of a combination logic circuit.

Further, there is an effect that it is possible to solve environmental problems due to excessive power consumption by reducing power consumption for processing a hash function in a virtual currency mining system or a stream cipher.

Further, since a series of combinational logic circuits for QR operation is segmented into predetermined bits to form pipelines of predetermined stages, the present disclosure has an advantage that a processing speed is increased, and a glitch is not propagated by the segmented bits and the pipeline stages.

### BRIEF DESCRIPTION OF THE DRAWINGS

FIG. 1 is a diagram showing the structure of a stream cipher unit to which a computing device for low-power quarter round operation according to an embodiment of the present disclosure is applied.

FIG. 2 is a diagram showing a quarter round circuit of a Salsa stream cipher algorithm to which a computing device for low-power quarter round operation according to an embodiment of the present disclosure is applied.

FIG. 3 is a diagram showing a quarter round circuit of a ChaCha stream cipher algorithm to which a computing device for low-power quarter round operation according to an embodiment of the present disclosure is applied.

FIG. 4 is a circuit diagram of a computing device for low-power quarter round operation, showing that glitches are suppressed from propagating by a latch and a clock delay according to an embodiment of the present disclosure.

FIG. 5 is a circuit diagram showing that, in a computing device for low-power quarter round operation according to an embodiment of the present disclosure, an adder is divided into a plurality of sub-adders and the result is latched through a plurality of sub-latches and glitches are suppressed from propagating by tuning a clock of the latch to a delay of the sub-adders.

FIG. 6 is a diagram showing an example when a computing device for low-power quarter round operation according to an embodiment of the present disclosure is applied to a Salsa stream cipher algorithm.

FIG. 7 is a diagram showing an example when a computing device for low-power quarter round operation according to an embodiment of the present disclosure is applied to a ChaCha stream cipher algorithm.

### BEST FORM FOR IMPLEMENTATION OF THE INVENTION

Hereafter, exemplary embodiments of a computing device for low-power quarter round operation of the present disclosure is described in detail with reference to the accompanying drawings. Like reference numerals given in the drawings indicate like components. Further, description of specific structures and functions in embodiments of the present disclosure are exemplified only to describe the embodiments of the present disclosure. Unless defined otherwise, it is to be understood that all the terms used in the specification including technical and scientific terms has the same meaning as those that are understood by those who skilled in the art. It will be further understood that terms defined in dictionaries that are commonly used should be interpreted as having meanings that are consistent with their meanings in the context of the relevant art and will not be interpreted in an idealized or overly formal sense unless expressly so defined herein.

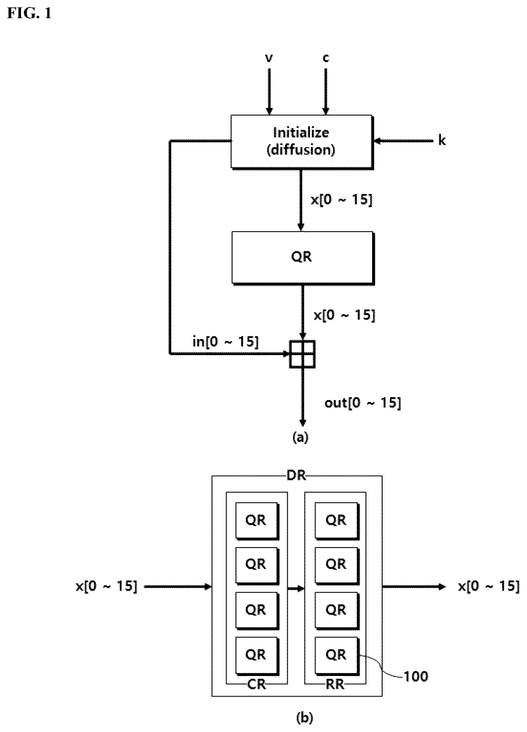

FIG. 1 is a diagram showing the structure of a stream cipher unit to which a computing device for low-power quarter round operation according to an embodiment of the present disclosure is applied.

As shown in (a) of FIG. 1, as for the structure of a stream cipher, it is seen that a computing device 100 for low-power quarter round operation according to an embodiment of the present disclosure performs a core function in the stream cipher, and power consumption, a processing speed, and optimization for a hardware area (chip size) of the computing device for low-power quarter round operation are very important issues in the stream cipher.

Salsa20 and ChaCha that are stream ciphers developed by Daniel J. Bernstein both have a QR module that performs ARX (add-rotate-XOR) operation such as 32-bit addition, XOR (bit-unit addition), and rotation. A core function is to map a 256-bit key (k), a 64-bit nonce (v), and 64-bit counter (c) to a 512-bit block of a key stream. That is, the internal state is composed of sixteen 32-bit words arranged in a 4×4 matrix. A cipher uses bitwise addition ⊕ (exclusive OR), 32-bit addition mod [symbol] and a predetermined distance rotation <<< in the internal state of the sixteen 32-bit words. It is possible to avoid a possibility of an attack when using only ARX (add-rotate-xor) work.

As shown in (b) of FIG. 1, it is possible to implement a structure by repeating individual QR modules several times rather than sequentially arranging the QR modules in accordance with a method of operating all of the QR modules in a stream cipher.

This configuration is briefly expressed into the following pseudo code.

for(i = 0; i <ROUNDS; i+=2) {
//odd round
QR(x[0], x[4], x[8], x[12]); //Column 1
QR(x[5], x[9], x[13], x[1]); //Column 1
QR(x[10], x[14], x[2], x[6]); //Column 1
QR(x[15], x[3], x[7], x[11]); //Column 1
//Even Round
QR(x[0], x[1], x[2], x[3]); //Row 1
QR(x[5], x[6], x[7], x[4]); //Row 1
QR(x[10], x[11], x[8], x[9]); //Row 1
QR(x[15], x[12], x[13], x[14]); //Row 1
}
for (i = 0; i <16; i++)
out[i] = x[i] + in[i];

That is, a Salsa20/8 core configured to repeatedly perform a Double Round (DR) module four times converts sixteen 32-bit input into sixteen 32-bit output. Eight QR modules are divided parallel into two same parts in the DR module and are composed of four Column Rounds (CR) and four Row Rounds (RR).

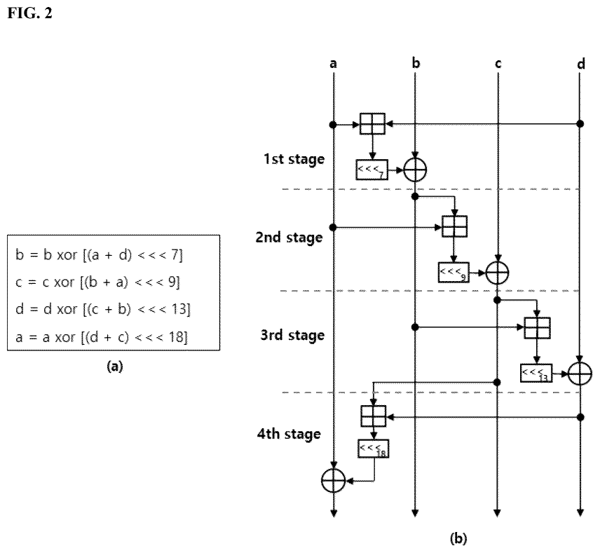

FIG. 2 is a diagram showing a quarter round circuit of a Salsa stream cipher algorithm to which a computing device for low-power quarter round operation according to an embodiment of the present disclosure is applied.

A logic that is performed in a Salsa stream cipher is as in (a) of FIG. 2. That is, a quarter round function transforms four 32-bit words (a, b, c, d) into relations, b=b xor [(a+d)<<<7], c=c xor [(b+a)<<<9], d=d xor [(c+b)<<<13], and a=a xor [(d+c)<<<18].

When the relations are configured into a circuit, they are configured as in (b) of FIG. 2. As shown in (b) of FIG. 2, when each QR is separated into the unit of ARX, it is possible to configure pipelines in four stages, and in this case, a total of four QRs (CRs and RRs) each need four clock cycles, so a total of eight clocks would be needed.

In this case, the reason of generating a glitch of an adder, rotation, and bitwise XOR is propagation of the carry of the adder, so there is a problem that a delay of output of the result of the adder is not uniform.

Accordingly, in the present disclosure, besides four steps of pipelines, an adder that adds two 32-bit words in each pipeline stage is configured by connecting eight 4-bit sub-adders through cascading and is configured to rotate and latch the results of the eight 4-bit sub-adders, whereby it is possible to isolate a glitch propagating with the carries of the sub-adders. It is apparent that the adder is divided into various numbers of sub-adders having various sizes.

In this case, the clock of each latch is configured to be delayed and latched by modeling the worst case delay of each adder. When a computing device for a quarter round operation is configured in this way, a glitch that is generated while ARX of four stages is performed is minimized, and when a transformation result is caught finally through a register (D-Flip Flop (DFF)), the processing speed of the computing device for a quarter round operation is increased by using a high-speed clock and propagation of a glitch inside and outside the pipeline stages is reduced, whereby a low-power circuit is configured.

Hereafter, how this configuration is applied to a ChaCha algorithm is described.

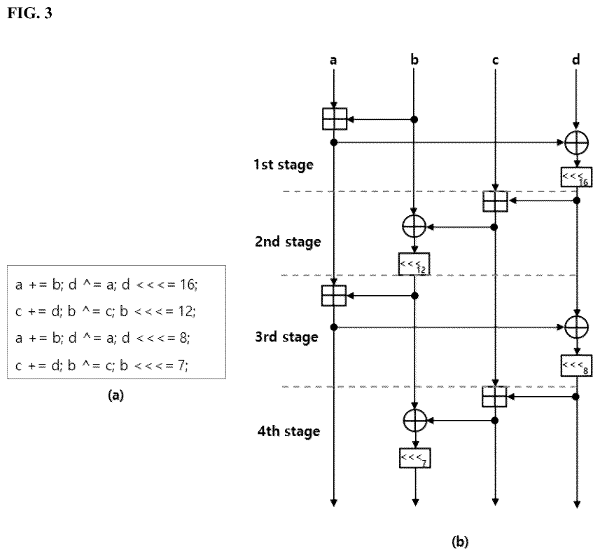

FIG. 3 is a diagram showing a quarter round circuit of a ChaCha stream cipher algorithm to which a computing device for low-power quarter round operation according to an embodiment of the present disclosure is applied.

The logic of a computing device for a quarter round operation that is performed in a ChaCha stream cipher is as in (a) of FIG. 3. That is, a ChaCha quarter round function transforms four 32-bit words (a, b, c, d) into relations, a+=b; d \hat{ }=a; d<<<=16; c+=d; b\hat{ }=c; b<<<=12; a+=b; d\hat{ }=a; d<<<=8; c+=d; b\hat{ }=c; b<<<<=7.

When the logic of the computing device for a quarter round of ChaCha is configured in a circuit, it is configured as in (b) of FIG. 3. As shown in (b) of FIG. 3, an adder, XOR, and rotation are performed through four stages.

In this case, since the reason of generating a glitch of an adder, bitwise XOR, and rotation is propagation of the carry of the adder, when the result of the adder is even rotated through bitwise XOR, there is a problem that the non-uniform output of the adder propagates even to rotation through bitwise XOR.

Accordingly, in the present disclosure, besides four steps of pipelines, an adder that adds two 32-bit words is configured by connecting eight 4-bit sub-adders through cascading and is configured to rotate and latch the results from the eight 4-bit sub-adders, whereby it is possible to prevent glitches from propagating with the carries of the sub-adders.

In this case too, the clock of each latch is configured to be delayed and latched by modeling the worst case delay of each adder. When a computing device for a quarter round operation is configured in this way, a glitch that is generated while AXR of four stages of is performed is minimized, and when a transformation result is caught finally through a register (DFF), the processing speed of the computing device for a quarter round operation is optimally increased by using a high-speed clock and propagation of a glitch inside and outside the pipelines is reduced, whereby a low-power circuit is configured.

Next, a circuit that divides an adder into a plurality of sub-adders and latches the result, thereby minimizing a glitch in accordance with the present disclosure is described.

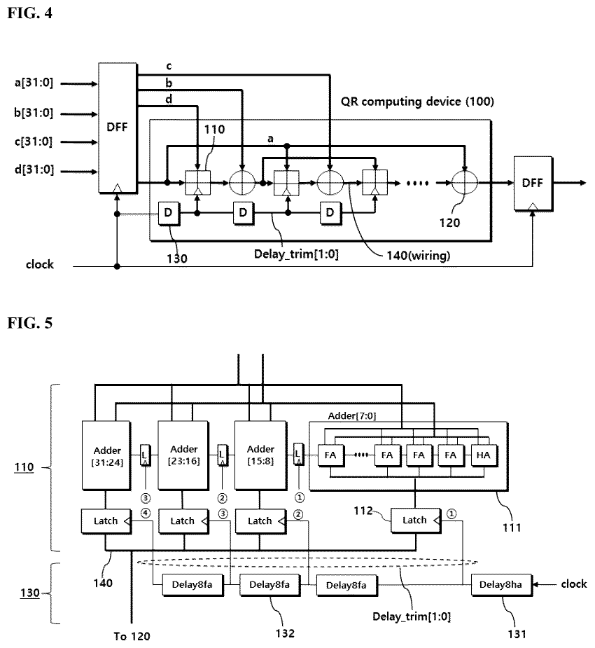

FIG. 4 is a circuit diagram of a computing device for low-power quarter round operation, showing that glitches are prevented from propagating by a latch and a clock delay according to an embodiment of the present disclosure.

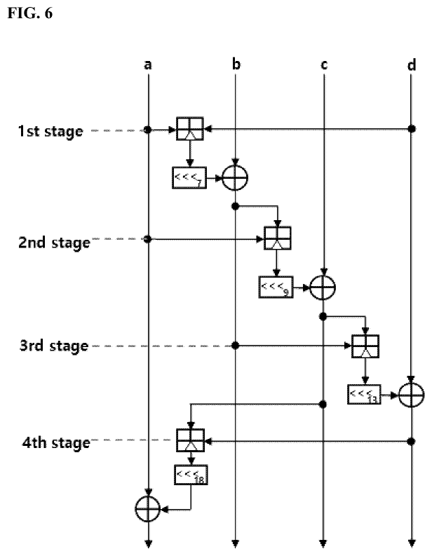

As shown in FIG. 4, the computing device 100 for low-power quarter round operation according to an embodiment of the present disclosure configures a first stage pipeline before and after which registers (DFF) are positioned, and configures a datapath to which adders 110 including a latch and XOR operation units 120 are sequentially connected is configured. In this configuration, each of the adders 110 has a plurality of sub-adders connected through cascading, and the result of each of the sub-adders is latched (see FIG. 5).

The adders 110 latch their results into delayed clocks with the XOR operation unit 120 therebetween, whereby pipelines based on a latch are configured in four stages. Since latching is performed in each of the four ARX stages on the basis of the adders 110, results are immediately caught by the register (DFF) after all of the four stages of ARX are performed. That is, since the pipelines according to the present disclosure have a structure that performs latching using a delay-modeled clock, it is a structure in which processing is output immediately after the processing is finished without a loss of surplus time in the processing speed between clocks as in common pipelines. Accordingly, the processing speed is very high.

For example, a 32-bit data word is configured such that eight 4-bit sub-adders are connected through cascading, and the result of each of the 4-bit sub-adders is latched into a clock having a delay minimally larger than the worst case delay of corresponding sub-adders.

In this case, many glitches are generated in the operation result of the 32-bit adder due to propagation of a carry. Accordingly, it is required to suppress glitches by forming sub-adders into as a small unit of bits as possible and then latching the results. As for XOR, since it is bitwise XOR, the delay is considered as being uniform. Accordingly, it does not generate excessive glitches.

Further, as for rotation, since it is configured through only wiring, a glitch is generated due to the length of wires in a semiconductor circuit of wire, but there is no other reason that generates a glitch. However, it is required to perform placement and routing (P&R) so that data can be transmitted as simultaneously as possible through a datapath by efficiently implementing wiring.

Further, since the XOR operation unit 120 is positioned between the adders, a delay due to XOR should be considered from the second adder 110.

Next, a clock delay unit that is applied to an adder, a latch unit, and latch is described in detail.

FIG. 5 is a circuit diagram showing that, in a computing device for low-power quarter round operation according to an embodiment of the present disclosure, an adder is divided into a plurality of sub-adders and the result is latched through a plurality of sub-latches and glitches are prevented from propagating by tuning a clock of the latch to a delay of the sub-adders.

As shown in FIG. 5, an adder 110 having a latch in the computing device 100 for low-power quarter round operation according to an embodiment of the present disclosure is divided into a plurality of sub-adders 111 and the result of each of the sub-adders 111 is latched by a latch unit 112 through a delayed clock 130.

In this case, the results of the small-scale sub-adders 111 are stabilized within a relatively short time and the latched results are glitch-freely provided to the next stage, so there is an effect that a glitch due to propagation of a carry is prevented in the unit of each the sub-adder 111.

Wherein, delay elements 131 and 132 are configured by continuously connecting inverter elements or by modeling a datapath for a worst case delay of each of the sub-adders 111.

Further, even though an original clock signal is divided into a plurality of high-speed clocks and then the high-speed clocks are input to sub-latches, respectively, to latch the results of the sub-adders, an effect that it is possible to reduce a glitch is obtained.

Meanwhile, in the present disclosure, a separate latch (using delay clocks \textcircled{1}˜\textcircled{3}) for latching output of carries is further included between the sub-adders 111. Further, a delay model of each sub-adder is composed of Delay8ha (a delay model corresponding to seven full-adders and two half-adders) and Delay8fa (a delay model corresponding to eight full-adders). Each of the delay models is used as a delay model by configuring an adder the same as each actual sub-adder or composed of a plurality of delay buffers.

Delay_trim[1:0] shows that when output for each delay model, for example, four delay models is selectively provided to an adder and the adder is supposed to use one of the delay models, for four delay models, the adder selects and uses 2-bit, that is, one of four delay models.

These delay models are commonly used in one QR operation unit and it is also possible to commonly provide delay models for a plurality of QRs (e.g., 4×4, 2×4, etc.) that is used for a stream cipher module. As a result, according to this configuration, it is possible to reduce hardware overhead due to delay models to an ignorable level. This technical feature is an apparent advantage of the QR operation unit provided in the present disclosure.

Further, according to a latched ARX structure in the present disclosure, since internal sub-adders of ARX and pipelines corresponding to the delay of XOR connecting output of the sub-adders are formed, designing into hardware having an optimal delay is possible. This optimal delay model results in improvement of the performance of all of QRs by improving the processing speed.

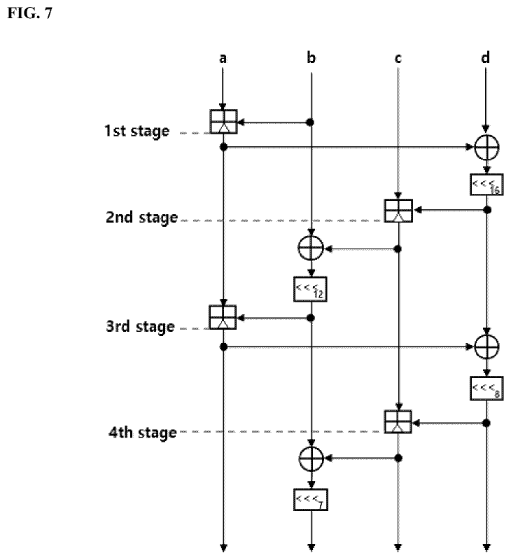

FIG. 6 is a diagram showing an example when a computing device for low-power quarter round operation according to an embodiment of the present disclosure is applied to a Salsa stream cipher algorithm.

As shown in FIG. 6, pipelines of four stages are formed by providing adders having a latch, and each of the stages configures a pipeline for a plurality of sub-adders. Further, a rotation unit is configured by only wiring.

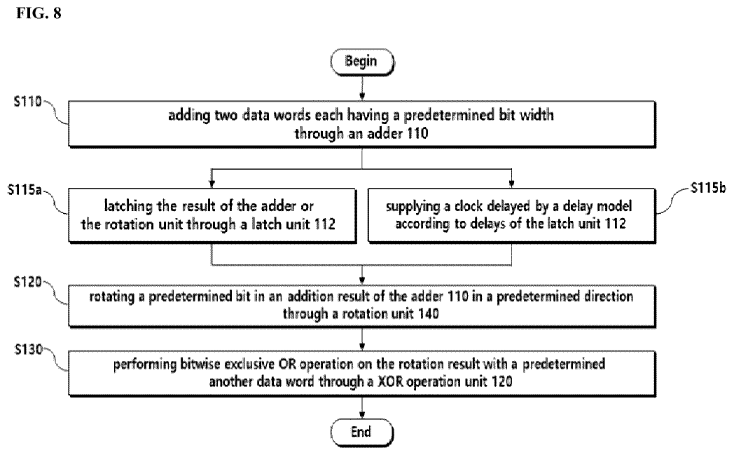

FIG. 7 is a diagram showing an example when a computing device for low-power quarter round operation according to an embodiment of the present disclosure is applied to a ChaCha stream cipher algorithm.

As shown in FIG. 7, even in a computing device for low-power quarter round operation that is used in a ChaCha stream cipher unit, each adder is configured as an adder having a latch and the adder having a latch is composed of sub-adders having a latch, whereby pipelines are configured.

Each computing device for a quarter round operation shown in FIGS. 6 and 7 has an advantage that a quarter round function is finished within a shortest time without a loss of surplus time between pipeline stages and glitches are prevented in an early stage in each pipeline stage, so a glitch does not propagate to the next operation.

As is seen from the above description, the present disclosure is characterized in that a series of combinational logic circuits for quarter round operation is segmented into predetermined bits to form pipelines of predetermined stages, so there is an advantage that a processing speed is increased and a glitch is not propagated by the segmented bits and the pipeline stages.

FIG. 8 is a flowchart showing a method of configuring a computing device for low-power quarter round operation according to an embodiment of the present disclosure.

As shown in FIG. 8, the method of configuring a computing device for low-power quarter round operation according to an embodiment of the present disclosure, first, is configured to perform adding two data words each having a predetermined bit width through an adder 110, in S110, and rotating a predetermined bit in an addition result of the adder 110 in a predetermined direction through a rotation unit 140, in S120. Next, the computing device is configured to perform bitwise exclusive OR-ing on the rotation result with a predetermined another data word, in S130. Further, the computing device is configured to perform latching the result of the adder or the rotation unit through a latch unit 112, in S115a. Propagation of glitches are prevented through the latching (S115a), whereby power consumption is reduced.

The latching in Si 15a is further configured to latch the addition result of the adder or the rotation result of the rotation unit in synchronization with carry propagation of the adder.

The rotating in S120 is performed by wiring such that output of the adder 111 is shifted to the left by predetermined bits and connected to input of the XOR operation unit 130, and a latch unit 112 is provided before or after the wiring, thereby suppressing glitches in the addition result of the adder 111 from propagating to the XOR operation unit 120.

The adding in S110 includes configuring a plurality of sub-adders having input in which the two data words are divided into smaller data words, and configuring cascading such that a carry is propagated and connected from an LSB to an MSB between the plurality of sub-adders.

The latching in S115a further includes configuring a plurality of divided sub-latch units to correspond to code words of the results of the sub-adders and delaying and supplying a clock of each of the sub-latch units more than the maximum delay of the sub-adders, thereby preventing glitches from propagating to the XOR operation unit.

Further, the method of configuring a computing device for low-power quarter round operation is configured to perform supplying a clock delayed by a delay model according to delays of the sub-adders to each of the plurality of sub-latch units in S115b.

Further, the method of configuring a computing device for low-power quarter round operation is applied to operate a quarter round function in a Salsa or ChaCha stream cipher unit.

As described above, the present invention has been described with reference to the exemplary embodiments illustrated in the drawings, those are only examples and may be changed and modified into other equivalent exemplary embodiments from the present invention by those skilled in the art. Therefore, the technical protection scope of the present invention should be determined by the following claims.

### INDUSTRIAL AVAILABILITY

The present invention in that a computing device for low-power quarter round operation is configured to perform high-speed processing by reducing a critical path delay of a datapath through a pipeline structure and reduce power consumption by maximally suppressing propagation of glitches by inserting a latch operating as a delay model according a delay into the result of a combination logic circuit. Therefore, it is industrially available for the present invention in that it is possible to solve environmental problems due to excessive use of power by reducing power consumption for processing a hash function in a virtual currency mining system or a stream cipher.

1. A computing device for low-power quarter round operation, comprising:
an adder adding two data words each having a predetermined bit width;
a rotation unit rotating predetermined bits in an addition result of the adder in a predetermined direction;
an XOR operation unit performing bitwise exclusive OR on the rotation result with a predetermined another data word; and
a latch unit latching the result of the adder or the rotation unit,
wherein power consumption is reduced by suppressing propagation of a glitch using the latch unit.

2. The computing device of claim 1,
wherein the latch unit is configured to latch the addition result of the adder or the rotation result of the rotation unit in synchronization with carry propagation of the adder, thereby suppressing propagation of glitches due to the result of the adder.

3. The computing device of claim 1,
wherein the rotation unit is configured to perform wiring such that output of the adder is shifted to the left by predetermined bits and connected to input of the XOR operation unit, and
the latch unit provided before or after the wiring, thereby suppressing glitches in the addition result of the adder from propagating to the XOR operation unit.

4. The computing device of claim 1,
wherein the adder is configured to comprise a plurality of sub-adders having input in which the two data words are divided into smaller data words, and is configured by cascading such that a carry is propagated and connected from a Least Significant Bit (LSB) to a Most Significant Bit (MSB) between the plurality of sub-adders.

5. The computing device of claim 4,
wherein the latch unit is divided into a plurality of sub-latch units to correspond to code words of the results of the sub-adders and a clock of each of the sub-latch units is delayed and supplied more than the maximum delay of the sub-adders, thereby suppressing glitches from propagating to the XOR operation unit.

6. The computing device of claim 5, further comprises:
a clock delay unit configured to supply a clock delayed by a delay model according to delays of the sub-adders to each of the plurality of sub-latch units.

7. The computing device of claim 1,
wherein the computing device is applied to operate a quarter round function in a Salsa or ChaCha stream cipher.

8. A method of configuring a computing device for low-power quarter round operation, comprises:
adding, by an adder, two data words each having a predetermined bit width through an adder;
rotating, by a rotation unit, predetermined bits in an addition result of the adder in a predetermined direction through a rotation unit;
operating, by an XOR operation unit bitwise exclusive OR on the rotation result with a predetermined another data word through an XOR operation unit; and
latching, by a latch unit, the result of the adder or the rotation unit through a latch unit,
wherein propagation of a glitch is prevented through the latching, whereby power consumption is reduced.

9. The method of claim 8,
wherein the latching is configured to latch the addition result of the adder or the rotation result of the rotation unit in synchronization with carry propagation of the adder, and
the rotating is configured to be performed by wiring such that output of the adder is shifted to the left by predetermined bits and connected to input of the XOR operation unit, and the latch unit is provided before or after the wiring, thereby suppressing glitches in the addition result of the adder from propagating to the XOR operation unit.

10. The method of claim 9,
wherein the adding is configured to comprise configuring a plurality of sub-adders having input in which the two data words are divided into smaller data words, and cascading such that a carry is propagated and connected from an LSB to an MSB between the plurality of sub-adders; and
the latching comprises configuring to divide the latch unit by a plurality of sub-latch units corresponding to code words of the results of the sub-adders and supplying a clock of each of the plurality of sub-latch units with a delay having more than a maximum delay of each of the corresponding sub-adders, thereby suppressing propagation of glitches to the XOR operation unit.

11. The method of claim 8, further comprises:
supplying a clock delayed by a delay model according to each delay of the sub-adders to each of the plurality of sub-latch units.

12. The method of claim 8,
wherein the method is applied to operate a quarter round function in a Salsa or ChaCha stream cipher.
